(19) United States
(12) Patent Application Publication
(10) Pub. No.: US 2008/0110071 A1
(43) Pub. Date: May 15, 2008

(54) Combination Picture Frame and Media Package

(76) Inventors: Donald Farnsworth, Oakland, CA (US); John Nava, Ojai, CA (US)

Correspondence Address: MARC E. HANKIN, ESQ., 11414 THURSTON CIRCLE, LOS ANGELES, CA, 90049, US

(21) Appl. No.: 11/719,094

(22) PCT Filed: Nov. 10, 2004
(86) PCT No.: PCT/US04/37465

§ 371 Date: May 10, 2007

(51) Int. Cl. A47G 1/06; G11B 33/04

(52) U.S. Cl. 40/722

(57) ABSTRACT

This invention is a picture frame that is capable of framing a, picture in a manner suitable for hanging on a wall or standing on a table while also packaging a compact disc, digital video disc, memory card, or alternate media. Various embodiments are described that facilitate economical manufacture of the picture while allowing an elegant display of the picture. Further, these embodiments allow the user to easily switch between pictures in the frame and remove and replace the disc. Thus, a unique picture frame is disclosed that functions both to store and to display pictures while also serving as a package or receptacle for disc shaped and other media.

### FIELD OF INVENTION

This invention relates, generally, to picture frames; more particularly to picture frames that are designed to also carry media such as compact discs (CD's), digital video discs (DVD's), memory cards, as well as souvenirs, toys, promotional premiums, and the like.

### BACKGROUND

The packaging and promotion of recorded music and movies has long been paired with visual art. Phonographs, compact cassettes, and compact discs are usually packaged along with a decorative cover featuring a picture of the band, an artistic element, or both. Meanwhile, music and movies have also been promoted through the use of visual arts in such mediums as pictures and posters, that can be used by aficionados to celebrate the recording artists and movies of their choosing while decorating their living space. Indeed, promotion of an artist's image through visual media has proven to be nearly as important to an artist's commercial success as promoting the music itself.

Although the packaging for such recorded media usually contains this visual art, it can be seldom be used for decorative purposes because the standard packaging it arrives in is not conducive to framing, hanging, standing on a table top, or otherwise making visible one's living space.

Several devices have been developed in order to overcome this problem. U.S. Pat. No. 6,431,354 to Irisawa, for example, discloses a cover for a disc storage case that allows the disc storage case to be stood vertically on a table-top or hung from a wall. This invention, however, is not integrated with the disc storage case, and thus must be purchased separately by the user. Further, it is limited because it can only accommodate a graphic the same size as a compact disc and can only display the graphic that arrives as the compact disc case cover. Thus, it is unsuited to promotions that utilize a graphic different from the compact disc case cover. U.S. Pat. No. 5,713,146 to Reeves, Sr. discloses a merchandise display within a picture frame. This invention is directed towards merchandise displays in stores and would also be unsuited to promotion because it is expensive, elaborate, and requires substantial effort to move the merchandise in and out of the picture frame. U.S. Pat. Nos. 4,981,211 to Janek and 4,856,213 to Hord both disclose combination picture frames and video cassette holders. Neither of these inventions, however, are compatible with compact discs or digital video discs, which are an increasingly common medium for music and videos. Further, both are elaborate designs requiring a number of parts and, thus, a high cost of manufacture. Finally, neither of these inventions includes an inexpensively-manufactured, easily-removable, integrated one-piece frame cover, which serves both decorative and protective purposes.

U.S. Pat. Nos. 6,179,119 to Manoogian and 6,505,738 to Lin both disclose means of displaying compact disc artwork by displaying the original case or inserts. U.S. Pat. No. 6,179,119 discloses assorted flanges that can be used to vertically prop or suspend the compact disc's insert. Meanwhile, U.S. Pat. No. 6,505,738 discloses a folding package that covers the compact disc case and features a flange and a hitch that allow the case to be vertically propped or suspended. These inventions, however, lack the ornamental features of picture frames, require several additional parts, and are limited to displaying graphics the same size as the compact disc case.

Other devices such as U.S. Pat. Nos. 5,052,564 to Zuzack and 6,446,799 to Simba disclose mountings to attach compact discs to one's wall. These, however, are separate devices from the compact disc packaging and, thus, are not useful for packaging or promotional means.

While picture frames have been developed for storage of various items while displaying a photograph, no such frame exists for storing compact discs. See, for example, U.S. Pat. Nos. 6,024,211 to Johnston (condoms), 6,526,636 to Bernhardt (cremated remains), 6,715,226 to Sikanovski (baby bibs), 6,216,856 to Park (assorted desk articles), 5,218,774 to Mullins (flowers), 4,777,745 to Rose (teeth), 4,195,729 to Macken (tobacco and other items), and several other displays known in the art. A suitable, inexpensively manufactured picture frame that is suitable for mass produced promotional materials is disclosed in U.S. Pat. No. 6,209,248 to Reinhard. This invention, however, does not include provisions for packaging compact discs.

Therefore, there is a need in the art for a picture frame that can also be used as a packaging mechanism for compact discs, digital video discs, memory cards, as well as souvenirs, toys, promotional premiums, and the like.

### SUMMARY OF THE INVENTION

This invention is directed towards overcoming the above problems by providing a picture frame that can also be used as a packaging mechanism for compact discs and digital video discs in particular as well as other digital media such as memory cards or souvenirs, toys, promotional premiums, and the like. More specifically, in one embodiment, a picture frame is manufactured such that the backing member doubles as a compact disc holder. In this embodiment, a simple two piece picture frame is comprised of a backing member that houses the compact disc and holds a photograph and a cover member that attaches to the backing member and includes a transparent center section, allowing a photograph laying beneath on the backing member to be viewed. Further, this invention can be used to display multiple sized images, including those of conventional compact disc cases, those of conventional photo prints (such as 5-inch by 7-inch or 8-inch by 10-inch), or unconventional sizes and shapes. Once the media is purchased, the consumer may choose to replace the included graphic with a picture of his or her own.

In another configuration, the combination picture frame and media package can be used as a packaging mechanism for memory cards. The invention provides an improvement on the commonplace disposable packaging used for these materials because it allows the purchaser to reuse the packaging as a picture frame. As such, the invention is especially useful because memory cards are commonly used for storing digital photographs. Thus, a consumer suing the combination picture frame and media package, the media card's package can also be used to store and display photographs.

The backing member can be constructed of vacuum formed plastic, injection molded plastic, sheet metal, formed paper, multiple materials, or other material(s) conducive to rigid construction. The center of the backing member may include an indentation to hold an enveloped compact disc or an indentation with a mounting that securely holds the compact disc in place. Also, an indentation is included to fixedly support a picture that can be inserted into the frame. In order to give the appearance of conventional, decorative picture frame moldings, an indented border can be included along the edges of the backing member, protruding above the plane of the frame. Further, this indented border can be integral with the border used to support the picture inserted into the frame.

The cover member can also be constructed of vacuum formed plastic, injection molded plastic, multiple materials, or any other material(s) facilitating a semi-rigid construction and a transparent center section. The cover member includes a planar center section that is transparent and serves to protect the picture while allowing it to be viewed and displayed. The border of the cover member serves to surround the backing member. If an indented border is included with the backing member, the cover member will be similarly shaped such that their borders lie flush with one another when the frame is assembled. The cover member can also include additional decorative features such as colors, designs, writing, and/or additional indentations. Further, the cover member can also include an integral mounting mechanism that allows it to be attached to the backing member. In one embodiment of the invention, the cover member includes an indentation, allowing it to house a small toy, souvenir, or other object within the picture frame.

Various mounting mechanisms can be used to affix the cover member to the backing member. For example, the cover member can be constructed with a series of bendable mounting tabs that a lowered to fix the cover member to the backing member and raised in order to release the cover member and remove the compact disc. Other known mounting mechanisms can be used such as a detent arrangement, velcro, adhesives, clips, ridges, slits, or other mounting mechanisms known in the art.

Additionally, the picture frame includes a means for displaying the frame in one's living space. These display means include one or more of the following: a hole or tab on the rear of the backing member to vertically attach the frame to a nail or hook on one's wall, a hole or indentation in the mounting tab of the cover member to vertically attach the frame to a nail or hook on one's wall, double-sided tape one the rear of the backing member to vertically attach the frame on one's wall, an easel-type flange that allows the frame to be stood on a table, or any of the many other mounting means known in the art.

Additionally, the combination picture frame and media package can be constructed to allow nesting of many such frames for shipping purposes. Nesting allows for more convenient and cost-effective shipping by allowing the upper surface of the frames to be packaged adjacent to the lower surface of the frames above them, thereby minimizing the amount of space in between frames. This allows for more convenient and cost-effective packaging because many more frames can be fit into a single box than would be possible without nesting.

### BRIEF DESCRIPTION OF THE DRAWINGS

FIG. 1 is an exploded illustration in three-dimensional view of one embodiment of the invention.

FIG. 2A is an exploded illustration in isometric view of another embodiment of the invention.

FIG. 2B is a cross sectional illustration of the backing member for this embodiment of the invention.

FIG. 3 is an exploded illustration in isometric view of another embodiment of the invention.

FIG. 4 is an illustration in perspective view of another embodiment of the invention.

FIG. 5A is an exploded illustration in isometric view of another embodiment of the invention.

FIG. 5B is a cross sectional illustration of the backing member for this embodiment of the invention.

FIG. 6A is an exploded illustration in isometric view of another embodiment of the invention.

FIG. 6B is an enlarged illustration of the hinge mechanism of one embodiment of the invention.

FIG. 7 is an exploded illustration in isometric view of another embodiment of the invention.

FIG. 8 is an exploded illustration in isometric view of another embodiment of the invention.

FIG. 9 is an exploded illustration in isometric view of another embodiment of the invention.

### DETAILED DESCRIPTION

In the following detailed description of various embodiments of the invention, numerous specific details are set forth in order to provide a thorough understanding of various aspects of one or more embodiments of the invention, however, one or more embodiments of the invention may be practiced without these specific details. In other instances, well-known methods, procedures, and/or components have not been described in detail so as not to unnecessarily obscure aspects of embodiments of the invention.

In the following description, certain terminology is used to describe certain features of one or more embodiments of the invention. For instance “picture frame” refers to any structure used to hang or display pictures, “picture” refers to any photograph, artwork, certificate for display, or other decorative item and “compact disc” any optical disc on which data such as music, movies, text, or graphic images are digitally encoded.

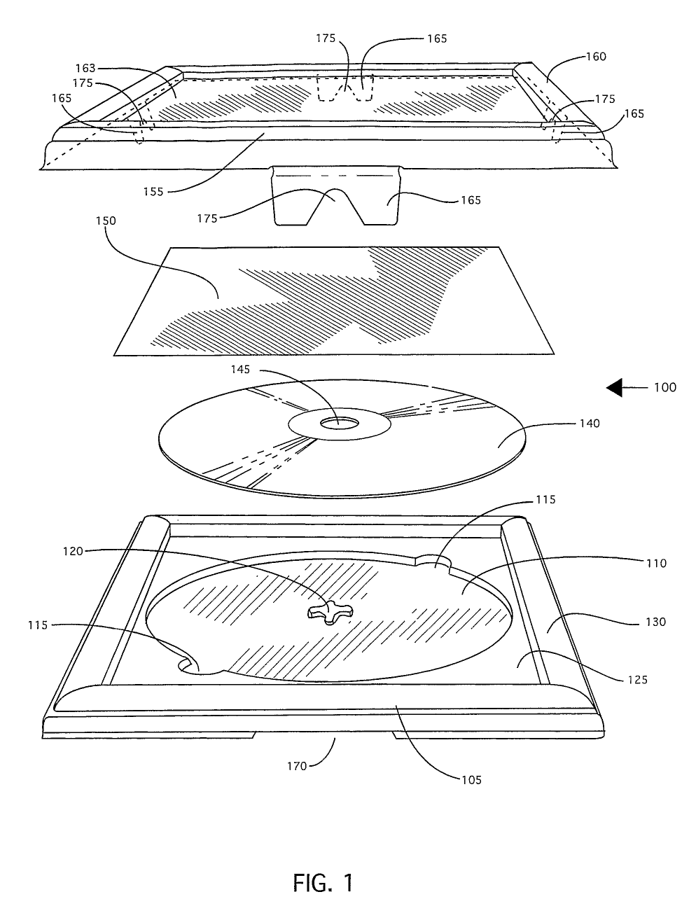

FIG. 1 is an exploded illustration in three-dimensional view of one embodiment of the invention. A vacuum-formed embodiment of the combination picture frame and media package 100 is illustrated exploded to show many of its constituent parts. These parts include a backing member 105 that serves as the base for the combination picture frame and media package 100. The backing member 105 is manufactured to include a compact disc holder 110 that allows storage of a compact disc within the backing member 105, two finger tabs 115 that allow one to easily remove a compact disc 140 that is placed in the backing member 105, a discharge tab 120 that securely holds the compact disc 140 once placed in the frame, and a platform 125 that is flat and designed to support a picture 150. An indented border 130 lines the edges of the backing member 105 and is formed such to give the decorative appearance of a conventional picture frame molding. A compact disc 140 is shown above the backing member 105 and is inserted into the compact disc holder 110 when the frame is assembled. When inserted, the hole 145 in the compact disc 140 will mate with the discharge tab 120 of the backing member 105 to hold the compact disc 140 securely in place. A picture 150 is shown above the compact disc 140 and can be placed on the platform 125 when the frame is assembled. A cover member 155 is shown above the picture 150 and serves to enclose the entire combination picture frame and media package 100. The cover member 155 includes an integrated center plate 163 that is transparent and allows one to view the picture 150. The edges 160 of the cover member 155 are elevated to fit snuggly over the indented borders 130 of the backing member 105 once the combination picture frame and media package 100 is assembled. Several tabs 165 are included on the cover member 155 and can be lowered around the grooves 170 on the backing member 105 when the combination picture frame and media package 100 is assembled, in order to secure the various parts. The tabs 165 can be raised in order to open the frame, remove the compact disc 140, or remove the picture 150. The tabs 165 each include a notch 175 that allows the frame to be hung easily from a wall.

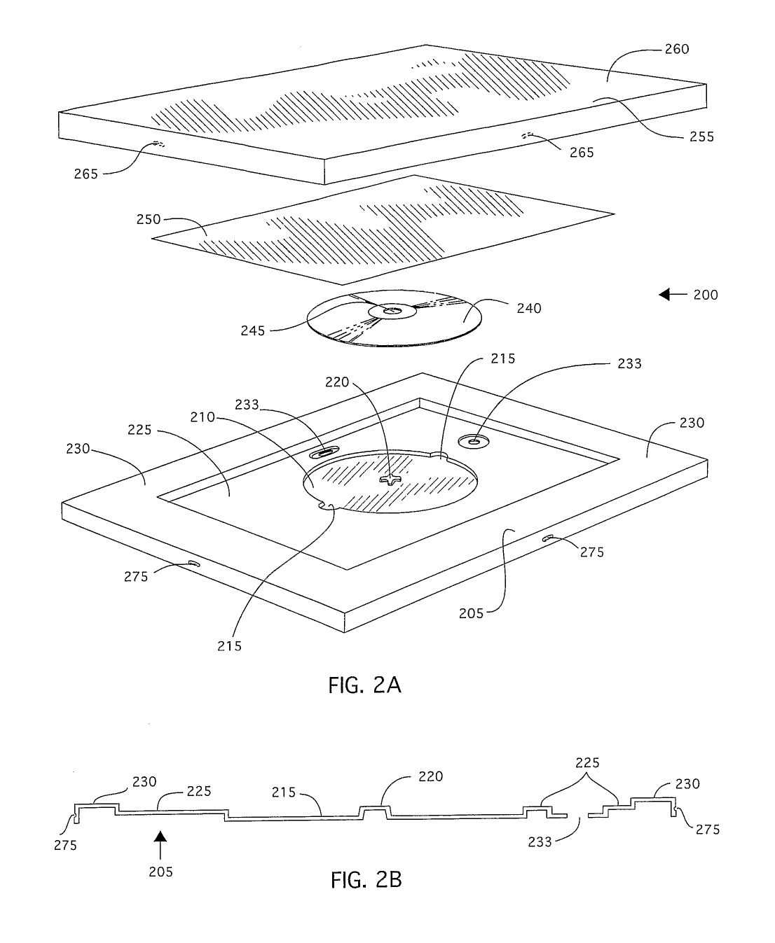

FIG. 2A is an exploded illustration in isometric view of another embodiment of the invention. An injection-molded embodiment of the combination picture frame and media package 200 is illustrated exploded to show many of its constituent parts. These parts include a backing member 205 that serves as the base for the combination picture frame and media package 200. The backing member 205 is manufactured to include a compact disc holder 210 that allows storage of a compact disc 240 within the frame, two finger tabs 215 that allow one to easily remove a compact disc 240 that is placed in the backing member, a discharge tab 220 that securely holds the compact disc 240 once placed in the frame, and a platform 225 that is flat and designed to support a picture 250. An indented border 230 lines the edges of the backing member 205 in order to give the decorative appearance of a conventional picture frame molding. The backing member 205 includes two hanging holes 233 that allow the combination picture frame and media package 200 to be easily hung on a wall; oriented either in landscape or portrait form, depending on the hanging hole 233 that is used. A compact disc 240 is shown above the backing member 205 and is inserted into the compact disc holder 210 when the frame is assembled. When inserted, the hole 245 in the compact disc 240 will mate with the discharge tab 220 in the backing member 205 to securely hold the compact disc 240. A picture 250 is shown above the compact disc and can be placed on the platform 225 when the frame is assembled. A cover member 255 is shown above the picture 250 and serves to enclose the entire combination picture frame and media package 200. The cover member 255 includes an integrated center plate 260 that is transparent and allows one to view the picture 250. Outer detents 265 are included on the cover member 255 to engage with the inner detents 275 on the backing member 205 to securely close all of the constituent parts when the combination picture frame and media package 200 is assembled.

FIG. 2B is a cross sectional illustration of the backing member for this embodiment of the invention. A backing member 205 is shown with its inner detents 275 on either edge. An indented border 230 is shown along the outside edge of the backing member 205. The platform 225 surrounds the compact disc holder 215. The discharge tab 220 is shown elevated from the compact disc holder 215. Finally, a hanging hole 233 is shown that allows the assembly to be easily hung from a wall.

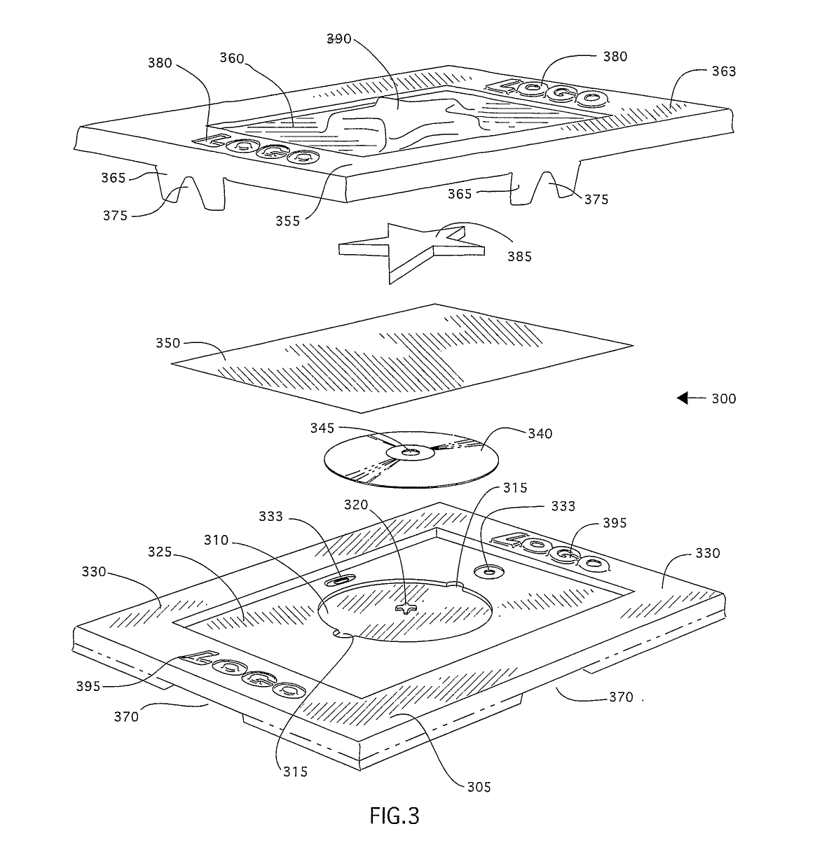

FIG. 3 is an exploded illustration in isometric view of another embodiment of the invention. A vacuum-formed embodiment of the combination picture frame and media package 300 is illustrated exploded to show many of its constituent parts. These parts include a backing member 305 that serves as the base for the combination picture frame and media package 300. The backing member 305 is manufactured to include a compact disc holder 310 that allows storage of a compact disc 340 within the frame, two finger tabs 315 that allow one to easily remove a compact disc 340 that is placed in the backing member, a discharge tab 320 that securely holds the compact disc 340 once placed in the frame, and a platform 325 that is flat and designed to support a picture. An indented border 330 lines the edges of the backing member 305 in order to give the decorative appearance of a conventional picture frame molding. The backing member 305 includes two hanging holes 333 that allows the combination picture frame and media package 300 to be easily hung on a wall, oriented either in landscape or portrait form, depending on the hanging hole 333 that is used. A compact disc 340 is shown above the backing member 305 and is inserted into the compact disc holder 310 when the frame is assembled. When inserted, the hole 345 in the compact disc 340 will mate with the discharge tab 320 of the backing member 305 in order to securely hold the compact disc 340 in pace. A picture 350 is shown above the compact disc and can be placed on the platform 325 when the frame is assembled. A toy 385 is shown above the picture 350 and can also be included inside the combination picture frame and media package 300. A cover member 355 is shown above the picture 350 and serves to enclose the entire combination picture frame and media package 300 when assembled. The cover member 355 includes an integrated center plate 360 that is transparent and allows one to view the picture 350. The center plate 360 is indented 390 in order to secure and display the toy 385 that is included with the combination picture frame and media package 300. The edges 363 of the cover member 355 are elevated to fit snuggly over the indented borders 330 of the backing member 305 once the combination picture frame and media package 300 is assembled. Additionally, the cover member 355 includes an elevated or indented logo 380 that can be a graphic or text used to adorn the combination picture frame and media package. This elevated or indented logo 380 on the cover member 355 matches a similar such logo 395 on the backing member 305, that will fit snuggly within one another upon assembly of the combination picture frame and media package 300. Several tabs 365 are included on the cover member 355 and can be lowered around the grooves 370 on the backing member 305 when the combination picture frame and media package 300 is assembled in order to secure the various parts. The tabs 365 can be raised in order to open the frame, remove the compact disc 340, or remove the picture 350. The tabs 365 each include a notch 375 that allows the frame to be hung easily from a wall.

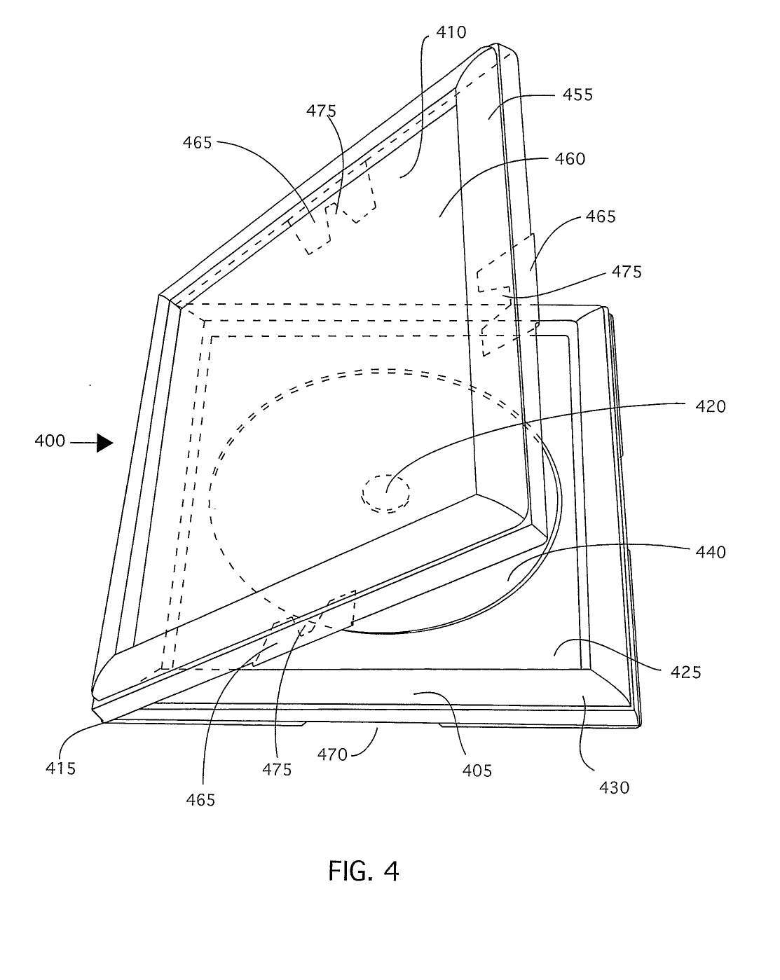

FIG. 4 is an illustration in perspective view of another embodiment of the invention. A vacuum-formed embodiment of the combination picture frame and media package 400 is shown in an opened position. In this embodiment of the invention, the backing member 405 is integrated with the cover member 410 via a hinge 415 running along a common seam of the backing member 405 and cover member 410. The backing member 305 is manufactured to include a compact disc holder 440 that allows storage of a compact disc within the frame, a discharge tab 420 that securely holds the compact disc once placed in the frame, and a platform 425 that is flat and designed to support a picture. An indented border molding 430 lines the edges of the backing member 405 in order to give the appearance of a conventional picture frame molding. A cover member 410 serves to enclose the entire combination picture frame and media package 400. The cover member 410 includes an integrated center plate 460 that is transparent and allows one to view a picture placed in the frame. The edges 455 of the cover member 410 are elevated to fit snuggly over the indented borders 430 of the backing member 405 once the combination picture frame and media package 400 is closed. Several tabs 465 are included on the cover member 410 and can be lowered around the grooves 470 on the backing member 405 when the combination picture frame and media package 400 is closed in order to secure the various parts. The tabs 465 can be raised in order to open the frame, remove a compact disc, or remove a picture. The tabs 465 each include a notch 475 that allows the frame to be hung easily from a wall.

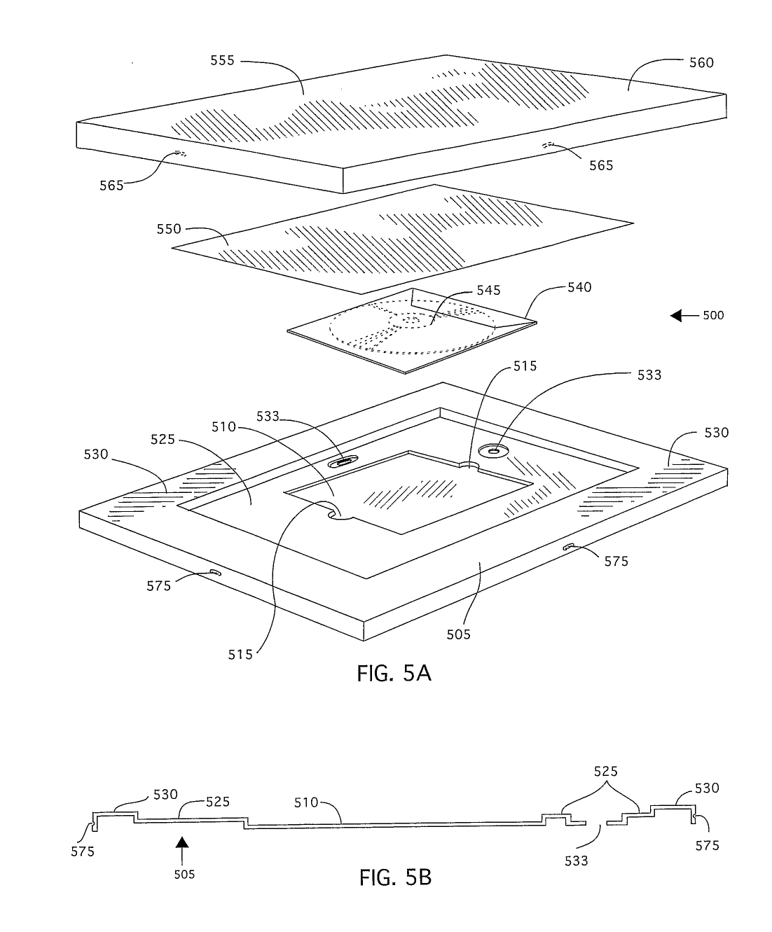

FIG. 5A is an exploded illustration in isometric view of another embodiment of the invention. An injection-molded embodiment of the combination picture frame and media package 500 is illustrated exploded to show many of its constituent parts. These parts include a backing member 505 that serves as the base for the combination picture frame and media package 500. The backing member 505 is manufactured to include a compact disc envelope holder 510 that allows storage of a compact disc envelope 540 within the frame, two finger tabs 515 that allow one to easily remove a compact disc envelope 540 that is placed in the compact disc envelope holder 510, and a platform 525 that is flat and designed to support a picture 550. An indented border molding 530 lines the edges of the backing member 505 in order to give the decorative appearance of a conventional picture frame molding. The backing member 505 includes two hanging holes 533 that allows the combination picture frame and media package 500 to be easily hung on a wall, oriented either in landscape or portrait form, depending on the hanging hole 533 that is used. A compact disc envelope 540 is shown above the backing member 505 and is inserted into the compact disc holder 510 when the frame is assembled. The compact disc envelope 540 is shown with a compact disc 545 inside. A picture 550 is shown above the compact disc holder 540 and can be placed on the platform 525 when the frame is assembled. A cover member 555 is shown above the picture 550 and serves to enclose the entire combination picture frame and media package 500. The cover member 555 includes an integrated center plate 560 that is transparent and allows one to view the picture 550. Outer detents 565 are included on the cover member 555 to engage with the inner detents 575 on the backing member 505 when the combination picture frame and media 500 is assembled.

FIG. 5B is a cross sectional illustration of the backing member for this embodiment of the invention. A backing member 505 is shown with its inner detents 575 on either edge. An indented border 530 is shown along the outside edge of the backing member 505. The platform 525 surrounds the compact disc envelope holder 510. Finally, a hanging hole 533 is shown that allows the assembly to be easily hung from a wall.

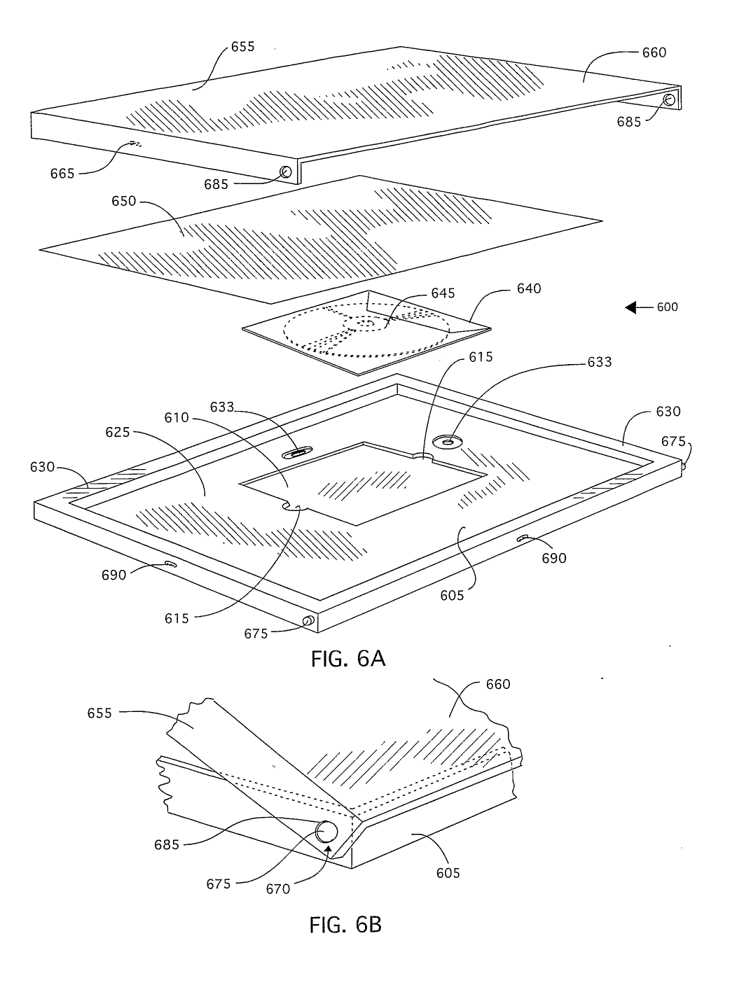

FIG. 6A is an exploded illustration in isometric view of another embodiment of the invention. An injection-molded embodiment of the combination picture frame and media package 600 is illustrated exploded to show many of its constituent parts. These parts include a backing member 605 that serves as the base for the combination picture frame and media package 600. The backing member 605 is manufactured to include a compact disc envelope holder 610 that allows storage of a compact disc envelope 640 within the frame, two finger tabs 615 that allow one to easily remove a compact disc envelope 640 that is placed in the compact disc envelope holder 610, and a platform 625 that is flat and designed to support a picture. An indented border 630 lines the edges of the backing member 605 in order to give the decorative appearance of a conventional picture frame molding. The backing member 605 includes two hanging holes 633 that allows the combination picture frame and media package 600 to be easily hung on a wall, oriented either in landscape or portrait form, depending on the hanging hole 633 that is used. This embodiment of the invention uses injection molded plastic in order to form the backing member 605 and cover member 655. The cover member 605 and cover member 655 are attached in this embodiment via a hinge mechanism 670. The hinge mechanism 670 consists of round tabs 675 at the edge of the backing member 605 that mate with the round holes 685 of the cover member 655 when the combination picture frame and media package 600 is assembled. A compact disc envelope 640 is shown above the backing member 605 and is inserted into the compact disc holder 610 when the frame is assembled. The compact disc envelope 640 is shown with a compact disc 645 inside. A picture 650 is shown above the compact disc holder 640 and can be placed on the platform 625 when the frame is assembled. A cover member 655 is shown above the picture 650 and serves to enclose the entire combination picture frame and media package 600. The cover member 655 includes an integrated center plate 660 that is transparent and allows one to view the picture 650. Outer detents 665 are included on the cover member 655 to mate with the inner detents 690 on the backing member 605 when the combination picture frame and media 600 is assembled.

FIG. 6B is an enlarged illustration of the hinge mechanism of one embodiment of the invention. The backing member 605 and cover member 655 are attached in this embodiment via a hinge mechanism 670. The hinge mechanism 670 consists of round pegs 675 at the edge of the backing member 605 that mate with the round holes 685 of the cover member 655 when the combination picture frame and media package 600 is assembled. These allow the cover member 655 to articulate along the hinge mechanism 670 and open and close the combination picture frame and media package 600.

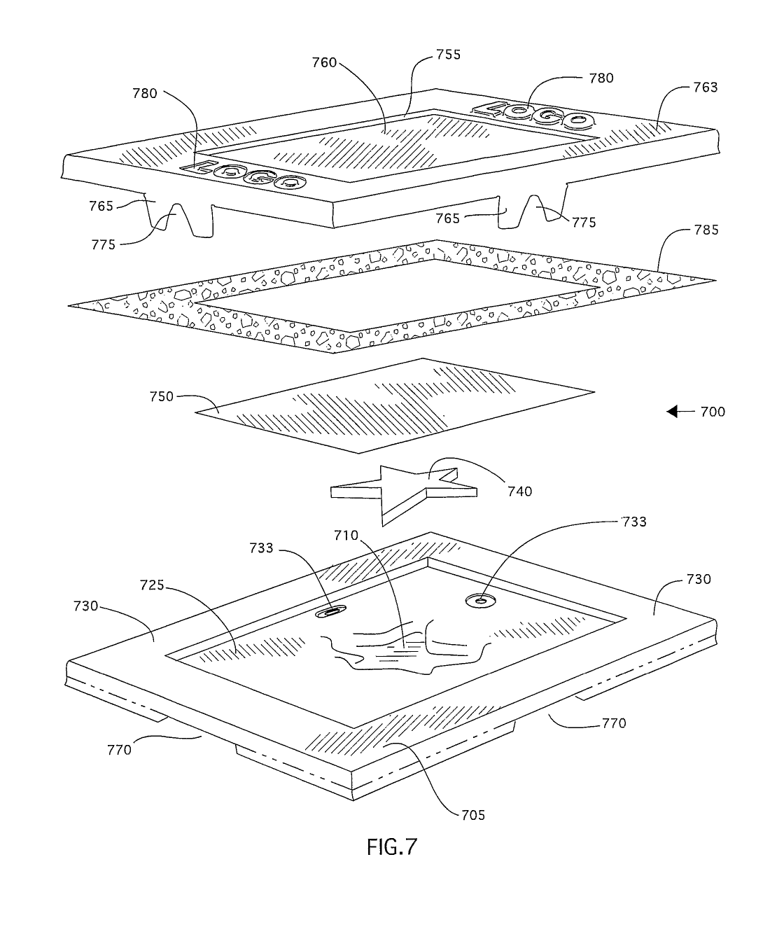

FIG. 7 is an exploded illustration in isometric view of another embodiment of the invention. A vacuum-formed embodiment of the combination picture frame and media package 700 is illustrated exploded to show many of its constituent parts. These parts include a backing member 705 that serves as the base for the combination picture frame and media package 700. The backing member 705 is manufactured to include a toy holder 710 that allows storage of a toy 740 within the frame and a platform 725 that is flat and designed to support a picture. An indented border 730 lines the edges of the backing member 705 in order to give the decorative appearance of a conventional picture frame molding. The backing member 705 includes two hanging holes 733 that allows the combination picture frame and media package 700 to be easily hung on a wall, oriented either in landscape or portrait form, depending on the hanging hole 333 that is used. A toy 740 is shown above the backing member 705 and is inserted into the toy holder 710 when the frame is assembled. A picture 750 is shown above the toy 740 and can be placed on the platform 725 when the frame is assembled. A decorative edge graphic 785 is shown above the picture 750 and can be place on the indented border 730 that may display graphic or written adornments for the combination picture frame and media package 700. The cover member 755 is shown above the decorative edge graphic 785 and includes an integrated center plate 760 that is transparent and allows one to view the picture 750. The edges 763 of the cover member 755 are transparent and elevated to fit snuggly over the indented borders 730 of the backing member 705 once the combination picture frame and media package 700 is assembled. Additionally, the cover member 755 includes an elevated or indented logo 780 that can be a graphic or text used to adorn the combination picture frame and media package. When assembled, the decorative edge graphic 785 is visible beneath the edges 763 of the cover member 755. Several tabs 765 are included on the cover member 755 and can be lowered around the grooves 770 on the backing member 705 when the combination picture frame and media package 700 is assembled in order to secure the various parts. The tabs 765 can be raised in order to open the frame, remove the toy 740, or remove the picture 750. The tabs 765 each include a notch 775 that allows the frame to be hung easily from a wall.

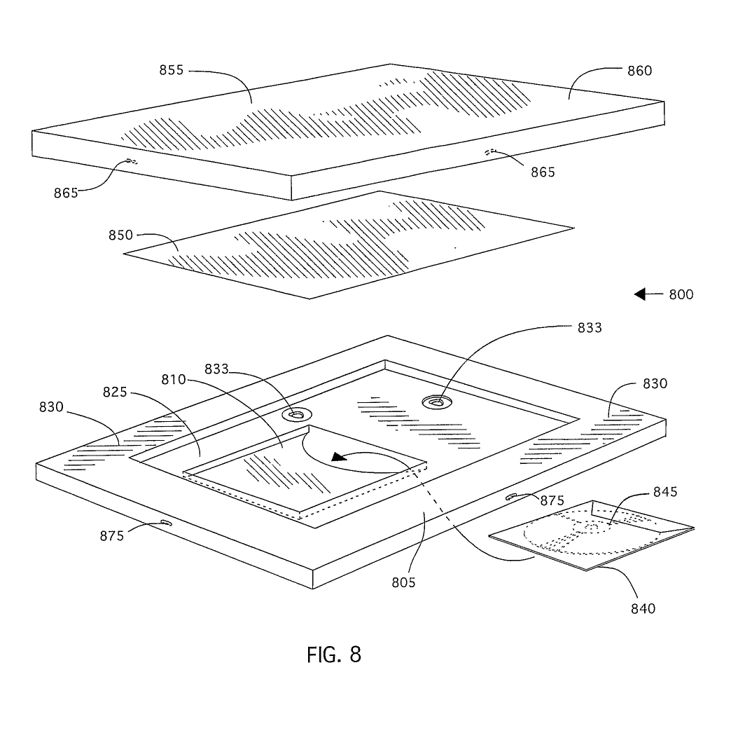

FIG. 8 is an exploded illustration in isometric view of another embodiment of the invention. An injection-molded embodiment of the combination picture frame and media package 800 is illustrated exploded to show many of its constituent parts. These parts include a backing member 805 that serves as the base for the combination picture frame and media package 800. The backing member 805 is manufactured to include a compact disc envelope holder 810 that allows storage of a compact disc envelope 840 on the rear of the frame and a platform 825 that is flat and designed to support a picture 850. This allows the compact disc envelope 840 to be removed from the combination picture frame and media package 800 without removing the cover member 855 or the picture 850. An indented border 830 lines the edges of the backing member 805 in order to give the decorative appearance of a conventional picture frame molding. The backing member 805 includes two hanging holes 833 that allows the combination picture frame and media package 800 to be easily hung on a wall, oriented either in landscape or portrait form, depending on the hanging hole 833 that is used. A compact disc envelope 840 is shown below the backing member 805 and is inserted and removed from the compact disc holder 810 at the rear of the frame. The compact disc envelope 840 is shown with a compact disc 845 inside. A picture 850 is shown above the backing member 805 and can be placed on the platform 825 when the frame is assembled. A cover member 855 is shown above the picture 850 and serves to enclose the entire combination picture frame and media package 800. The cover member 855 includes an integrated center plate 860 that is transparent and allows one to view the picture 850. Outer detents 865 are included on the cover member 855 to engage with the inner detents 875 on the backing member 805 when the combination picture frame and media 800 is assembled.

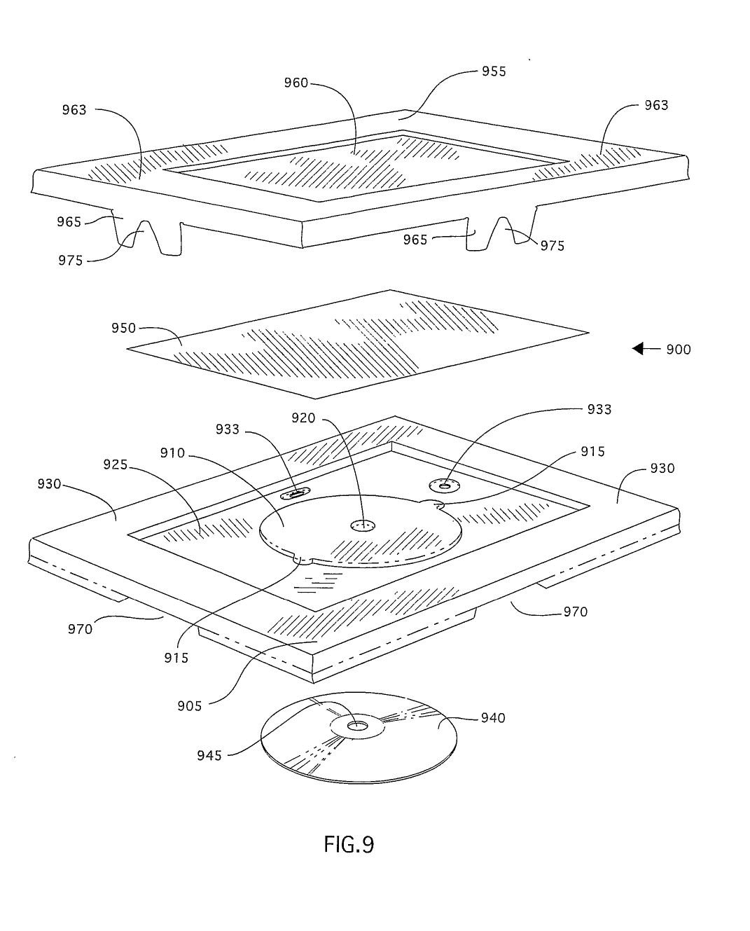

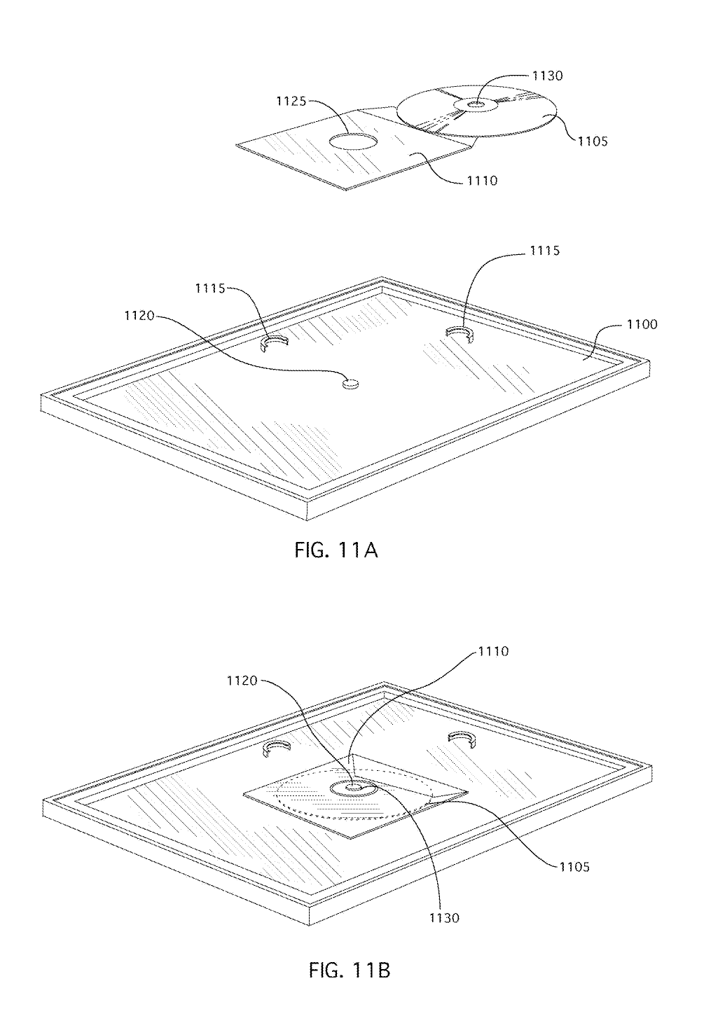

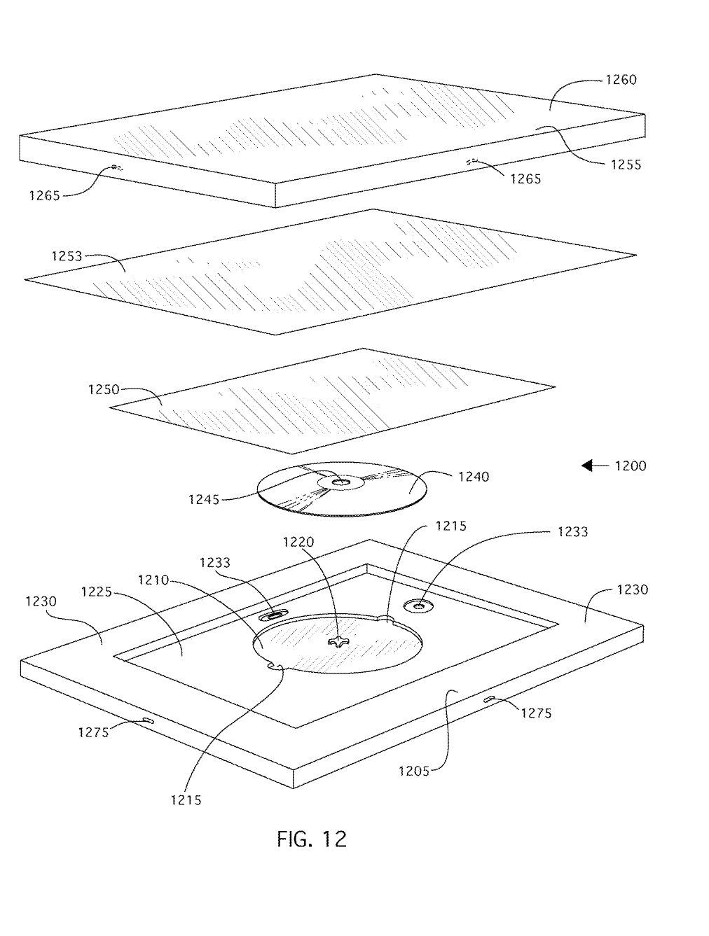

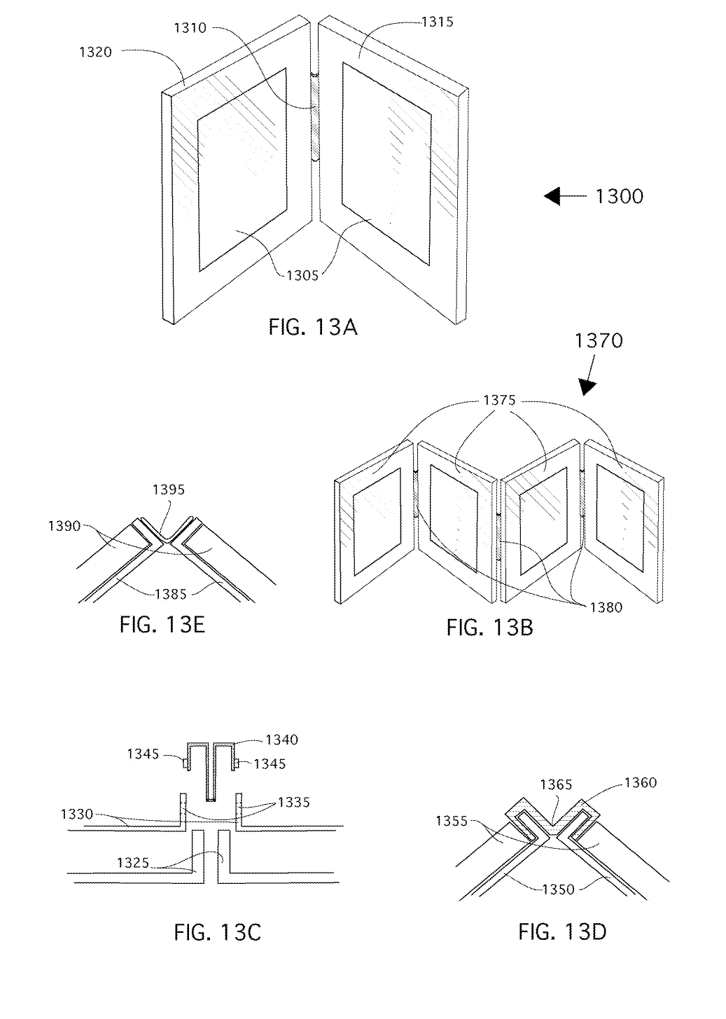

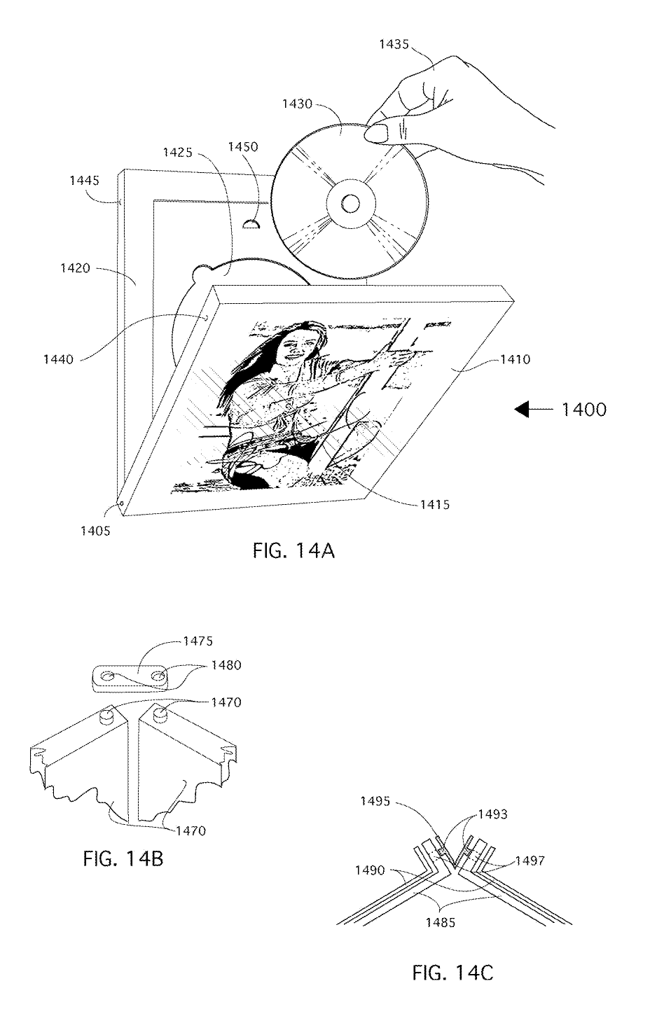

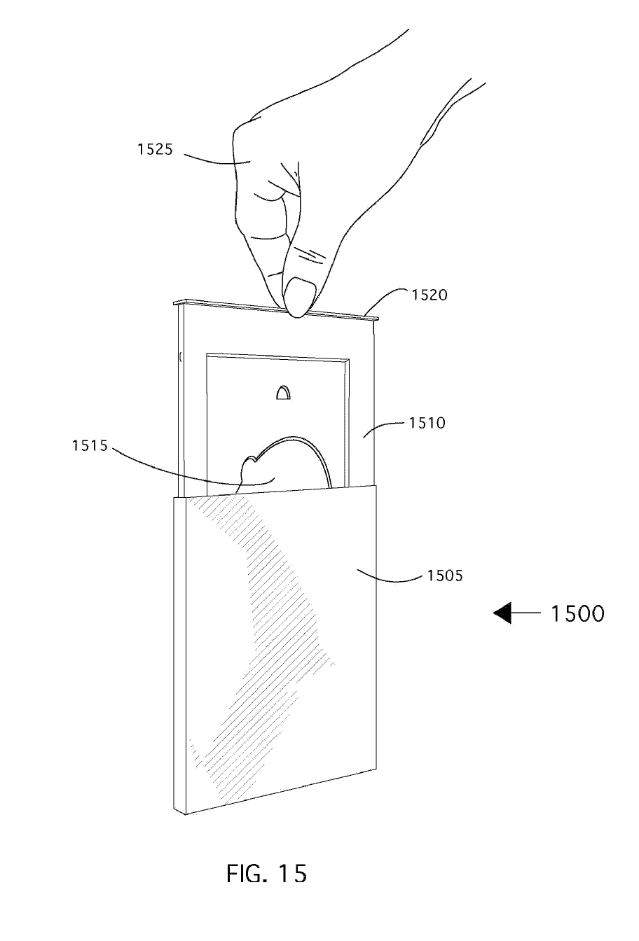

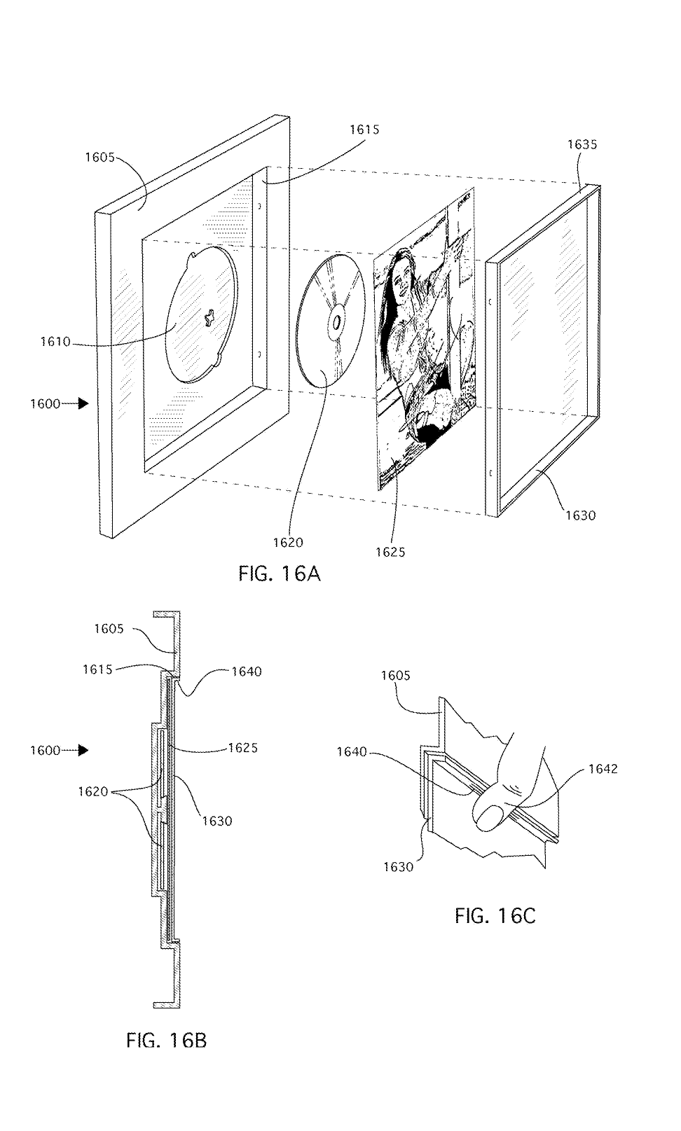

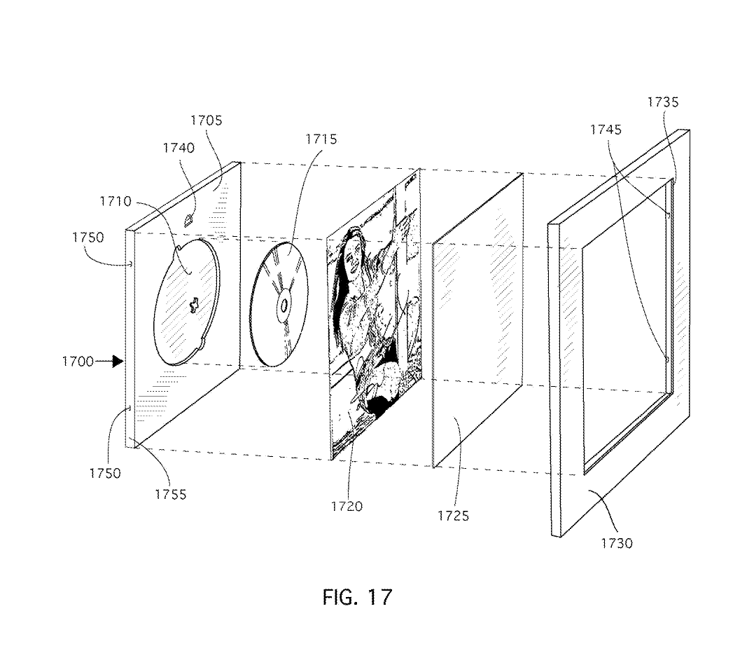

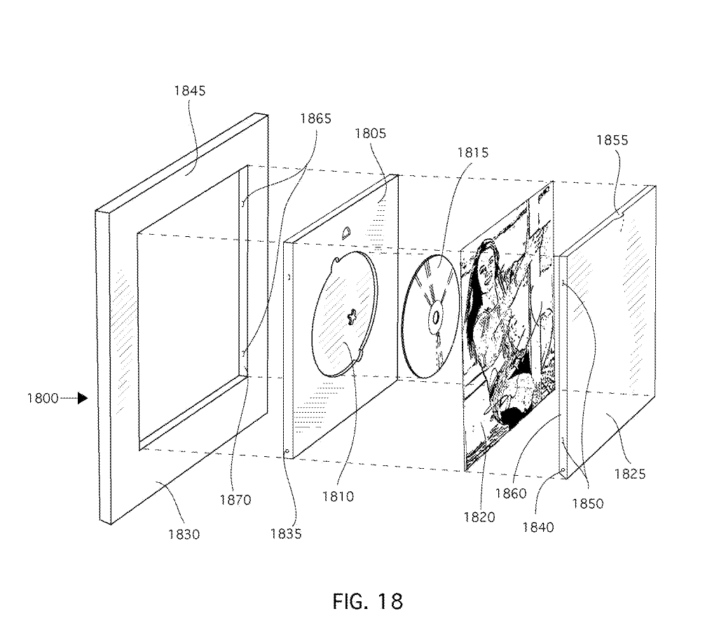

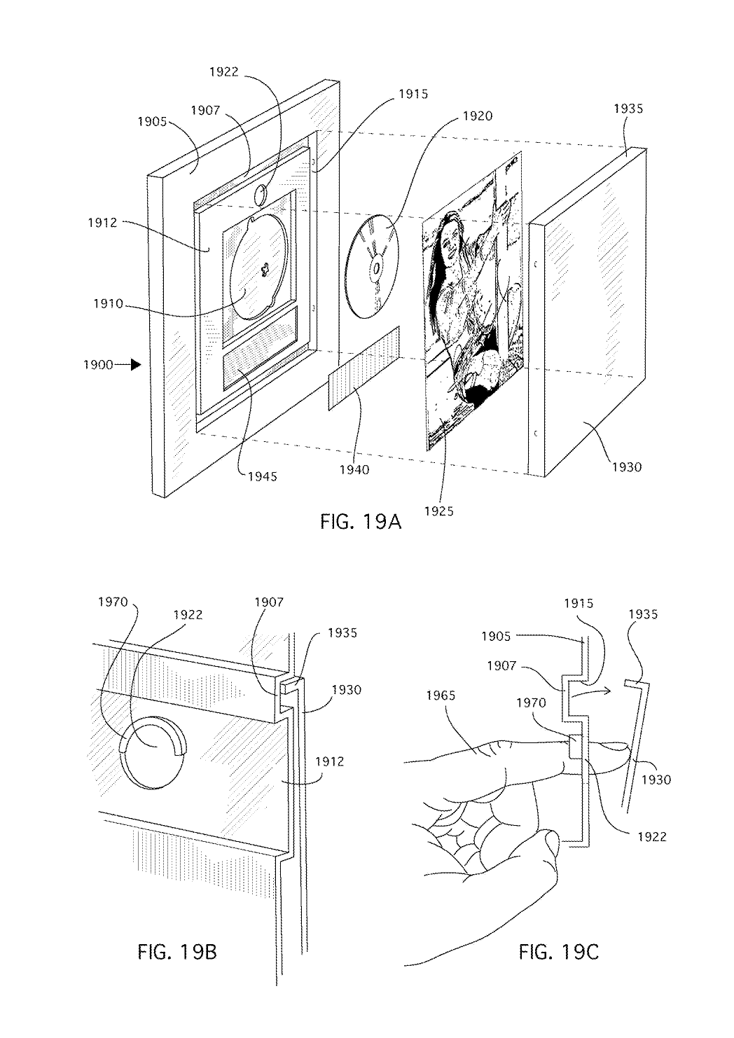

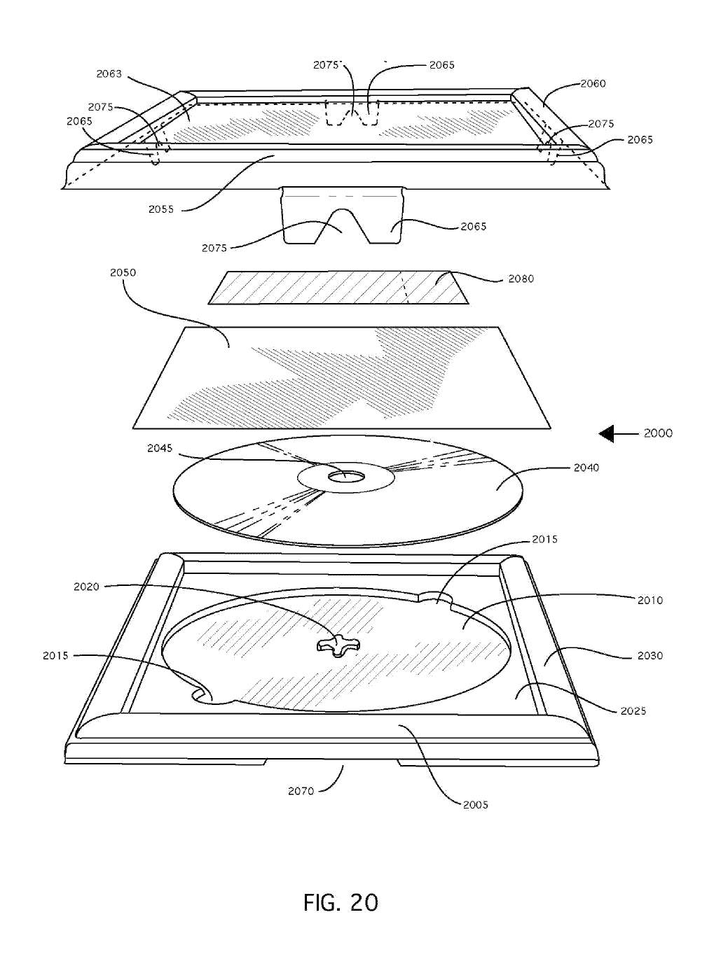

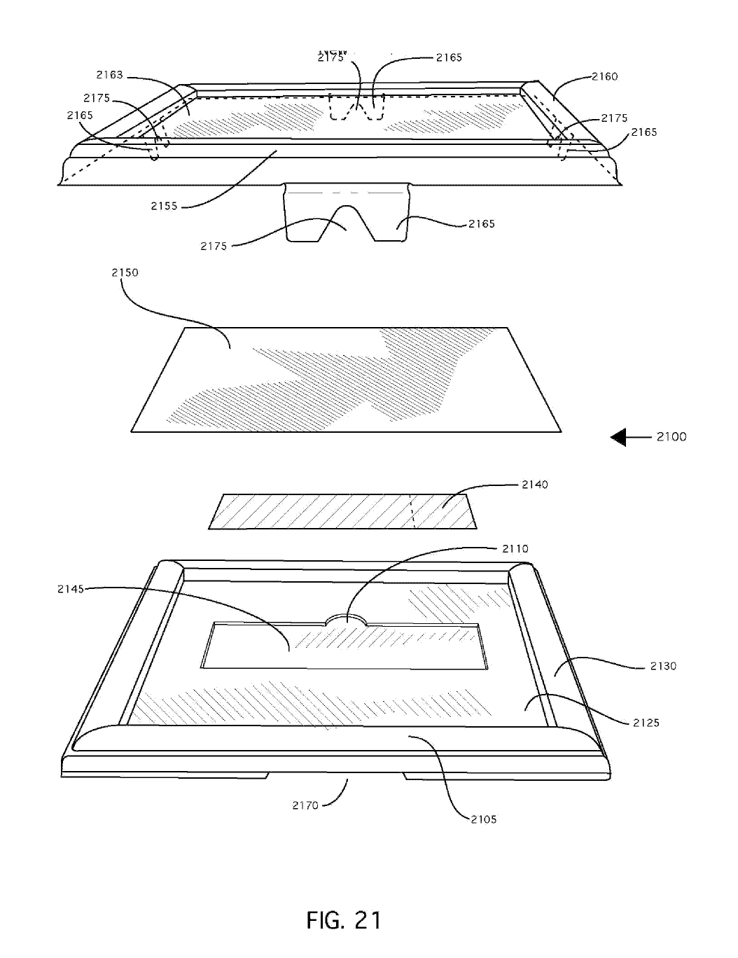

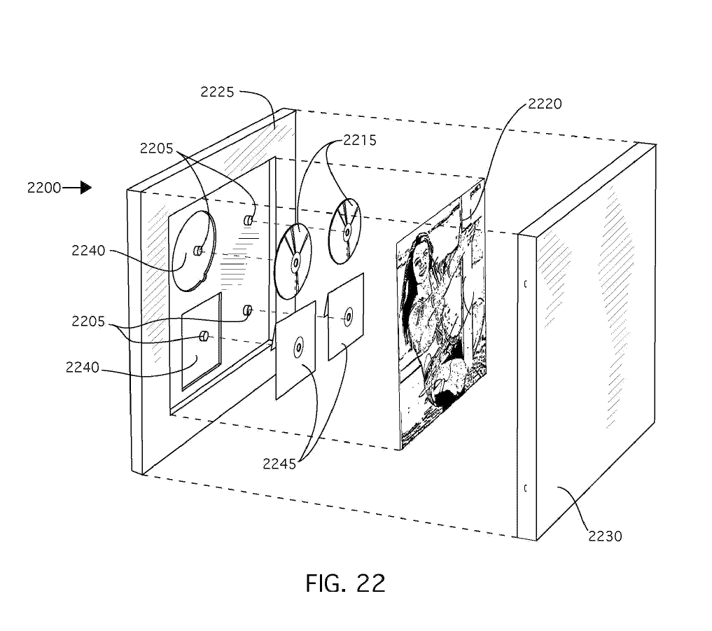

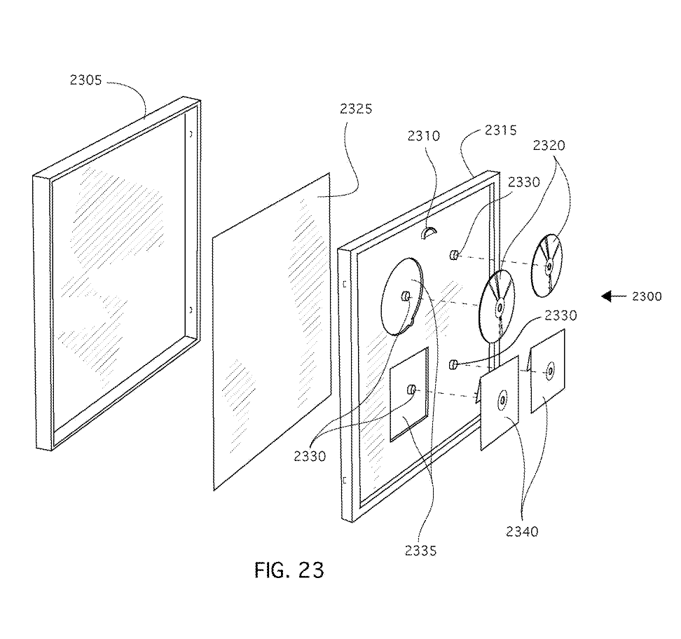

FIG. 9 is an exploded illustration in isometric view of another embodiment of the invention. A vacuum-formed embodiment of the combination picture frame and media package 900 is illustrated exploded to show many of its constituent parts. These parts include a backing member 905 that serves as the base for the combination picture frame and media package 900. The backing member 905 is manufactured to include a compact disc holder 910 that allows storage of a compact disc 940 on the rear side of the frame, two finger tabs on the rear side of the frame 915 that allow one to easily remove a compact disc 940 that is placed on the rear of the backing member, a discharge tab 920 that securely holds the compact disc 940 once placed in the frame, and a platform 925 that is flat and designed to support a picture 950. An indented border 930 lines the edges of the backing member 905 in order to give the decorative appearance of a conventional picture frame molding. The backing member 905 includes two hanging holes 933 that allow the combination picture frame and media package 900 to be easily hung on a wall; oriented either in landscape or portrait form, depending on the hanging hole 933 that is used. A compact disc 940 is shown below the backing member 905 and is inserted into the compact disc holder 910 when the frame is assembled. When inserted, the hole 945 in the compact disc 940 will mate with the discharge tab 920 in the backing member 905 to securely hold the compact disc 940. A picture 950 is shown above the compact disc and can be placed on the platform 925 when the frame is assembled. A cover member 955 is shown above the picture 950 and serves to enclose the entire combination picture frame and media package 900. The cover member 955 includes an integrated center plate 960 that is transparent and allows one to view the picture 950. The cover member 955 also includes a border 963 along its edges that, upon assembly, will lie flush with the indented border 930 of the backing member 905 to give the decorative appearance of a conventional picture frame molding. Several tabs 965 are included on the cover member 955 and can be lowered around the grooves 970 on the backing member 905 when the combination picture frame and media package 900 is assembled, in order to secure the various parts. The tabs 965 can be raised in order to open the frame, remove the compact disc 940, or remove the picture 950. The tabs 965 each include a notch 975 that allows the frame to be hung easily from a wall.

We claim:

1. A picture frame, comprising,
an area for the display of photographs, artwork, and the like; and
an area for the storage of compact discs, digital video discs, memory cards and the like adjacent to the area for the display of photographs, artwork, and the like.

2. A picture frame as defined in claim 1 wherein said picture frame is comprised of:
a backing member that includes a compartment for the storage of compact discs, digital video discs, memory cards and the like and a receiving compartment for the display of photographs, artwork, and the like,
a cover member of substantially the same size and form as said backing member and includes a transparent planar center section and a border section, the cover member being configured to attach to the backing member to form a picture receiving and viewing compartment, and
a locking means for connecting said backing member to said cover member.

3. A picture frame as defined in claim 2 wherein:
said backing member is vacuum formed from a thin, flexible plastic sheet material, and
said cover member is vacuum formed from a thin, flexible plastic sheet material.

4. A picture frame as described in claim 2 wherein said locking means include a plurality of tabs each moveable between a locking position and a unlocking position.

5. A picture frame as described in claim 4 wherein said plurality of tabs are integral with said cover member.

6. A picture frame as described in claim 4 wherein said plurality of tabs are integral with said backing member.

7. A picture frame as described in claim 2 wherein said locking means include a plurality of outer detents on the cover member and inner detents on the backing member that attach to one another.

8. A picture frame as described in claim 2 wherein said backing member includes a decorative border area that is convex with respect to the backing member and the cover member including a border area that is similar in shape and size to the border area of the backing member and curved concavely with respect to the backing member such that the two lay flush with one another upon assembly.

9. A picture frame as described in claim 2 wherein said backing member includes a border area that is flat and the border area of the cover member is similarly flat such that the two lay flush with one another upon assembly.

10. A picture frame as described in claim 2 wherein the cover member is formed to include an indented logo, design, text, or other decorative feature.

11. A picture frame as described in claim 2 wherein the cover member is formed to include an indented storage area that can accommodate a toy, souvenir, or other object beneath then cover member and above a picture.

12. A picture frame as described in claim 2 wherein said backing member is hingedly attached to said cover member.

13. A picture frame as described in claim 2 wherein said backing member is integrally connected to said cover member.

14. The picture frame as described in claim 1 wherein an attachment is included at the rear of the backing member that can be used to support the picture frame on a horizontal surface.

15. The picture frame as described in claim 14 wherein the attachment has an upper end and a lower end, said upper end including a flared tip section which passes through a pair of slits from in said backing member to lockingly connect said attachment to said packing member, whereby said lower end is located a spaced distance from said backing member to permit said picture to stand in an upright position with said lower end and said border resting on a supporting surface.

16. The picture frame as described in claim 15 wherein a second pair of slits are formed within said backing member, wherein each of said two pairs of slits are located spaced apart and angularly displaced from each other, said attachment connectable with either of said pair of slits, and wherein attachment with one of said pair of slits locates said picture frame in a first orientation, and wherein attachment with the remaining pair of slits locates said picture frame in a second orientation, said second orientation being ninety degrees displaced relative to said first orientation.

17. The picture frame as described in claim 2 wherein both the backing member and the cover member are made of a rigid plastic material.

18. The picture frame as described in claim 2 wherein the backing member is made of a flexible plastic material and the cover member is made of a rigid plastic material.

19. The picture frame as described in claim 2 wherein the backing member is made of a rigid plastic material and the cover member is made of a flexible plastic material.

20. The picture frame as described in claim 2 wherein the cover member is transparent in all areas to allow a viewer to see text, design, or graphics included below the cover member.

21. The picture frame as described in claim 2 wherein the backing member is formed to store an envelope containing a compact disc, digital video disc, memory card, or other similar media.

22. The picture frame as described in claim 17 wherein the picture frame includes a hinge mechanism that attaches the cover member and the backing member.

23. The picture frame as described in claim 22 wherein the hinge mechanism is comprised of round pegs attached to the backing member and round holes on the cover member, the pegs and holes designed to fit matingly to one another when the frame is assembled and allow the cover member to articulate radially along the pegs of the hinge mechanism.

24. The picture frame as described in claim 22 wherein the hinge mechanism is comprised of round holes attached to the backing member and round pegs on the cover member, the pegs and holes designed to fit matingly to one another when the frame is assembled and allow the cover member to articulate radially along the pegs of the hinge mechanism.

25. A picture frame as described in claim 2 wherein the backing member includes a compartment on its rear side for the storage of a compact disc, digital video disc, memory card, or the like.

26. A picture frame as described in claim 2 wherein the backing member includes a compartment on its rear side for the storage of an envelope containing a compact disc, digital video disc, memory card, or the like.

27. A picture frame comprising:
a backing member that includes a compartment for the storage of a toy, a souvenir, or other similar object,
a cover member of substantially the same size and form as said backing member and includes a transparent planar center section and a border section, the cover member being configured to attach to the backing member to form a picture receiving and viewing compartment, and
a locking means for connecting said backing member to said cover member.

28. A picture frame as defined in claim 27 wherein:
said backing member is vacuum formed from a thin, flexible plastic sheet material, and
said cover member is vacuum formed from a thin, flexible plastic sheet material.

29. A picture frame as described in claim 27 wherein said locking means include a plurality of tabs each moveable between a locking position and a unlocking position.

30. A picture frame as described in claim 29 wherein said plurality of tabs are integral with said cover member.

31. A picture frame as described in claim 29 wherein said plurality of tabs are integral with said backing member.

32. A picture frame as described in claim 27 wherein said locking means include a plurality of outer detents on the cover member and inner detents on the backing member that attach to one another.

33. A picture frame as described in claim 27 wherein said backing member includes a decorative border area that is convex with respect to the backing member and the cover member including a border area that is similar in shape and size to the border area of the backing member and curved concavely with respect to the backing member such that the two lay flush with one another upon assembly.

34. A picture frame as described in claim 27 wherein said backing member includes a border area that is flat and the border area of the cover member is similarly flat such that the two lay flush with one another upon assembly.

35. A picture frame as described in claim 27 wherein the cover member is formed to include and indented logo, design, text, or other decorative feature.

36. A picture frame as described in claim 27 wherein said backing member is hingedly attached to said cover member.

37. The picture frame as described in claim 27 wherein an attachment is included at the rear of the backing member that can be used to support the picture frame on a horizontal surface.

38. The picture frame as described in claim 37 wherein the attachment his a upper end and a lower end, said upper end including a flared tip section which passes through a pair of slits from in said backing member to lockingly connect said attachment to said packing member, whereby said lower end is located a spaced distance from said backing member to permit said picture to stand in an upright position with said lower end and said border resting on a supporting surface.

39. The picture frame as described in claim 38 wherein second pair of slits are formed within said backing member, wherein each of said two pairs of slits are located spaced apart and angularly displaced from each other, said attachment connectable with either of said pair of slits, and wherein attachment with one of said pair of slits locates said picture frame in a first orientation, and wherein attachment with the remaining pair of slits locates said picture frame in a second orientation, said second orientation being ninety degrees displaced relative to said first orientation.

40. The picture frame as described in claim 27 wherein both the backing member and the cover member are made of a rigid plastic material.

41. The picture frame as described in claim 27 wherein the backing member is made of a flexible plastic material and the cover member is made of a rigid plastic material.

42. The picture frame as described in claim 27 wherein the backing member is made of a rigid plastic material and the cover member is made of a flexible plastic material.

43. The picture frame as described in claim 27 wherein the cover member is transparent in all areas to allow a viewer to see text, design, or graphics included below the cover member.

44. A picture frame as described in claim 27 wherein the backing member includes a compartment for the storage of a compact disc, digital video disc, memory card, or the like.

45. A picture frame as described in claim 27 wherein the backing member includes a compartment for the storage of an envelope containing a compact disc, digital video disc, memory card, or the like.

46. The picture frame as described in claim 40 wherein the picture frame includes a hinge mechanism that attaches the cover member and the backing member.

47. The picture frame as described in claim 46 wherein the hinge mechanism is comprised of round pegs attached to the backing member and round holes on the cover member, the pegs and holes designed to fit matingly to one another when the frame is assembled and allow the cover member to articulate radially along the pegs of the hinge mechanism.

48. The picture frame as described in claim 46 wherein the hinge mechanism is comprised of round holes attached to the backing member and round pegs on the cover member, the pegs and holes designed to fit matingly to one another when the frame is assembled and allow the cover member to articulate radially along the pegs of the hinge mechanism.
